(19) United States
(12) Patent Application Publication
(10) Pub. No.: US 2020/0213844 A1
(43) Pub. Date: Jul. 2, 2020

(54) COMMUNICATION METHOD, COMMUNICATION APPARATUS AND ELECTRONIC DEVICE

(71) Applicant: BAIDU ONLINE NETWORK TECHNOLOGY (BEIJING) CO., LTD., Beijing (CN)

(72) Inventors: Peng WANG, Beijing (CN); Guoguo CHEN, Beijing (CN); Fei NIU, Beijing (CN); Aihui AN, Beijing (CN); Junlian HU, Beijing (CN)

(21) Appl. No.: 16/726,818

(22) Filed: Dec. 24, 2019

(30) Foreign Application Priority Data
Jan. 2, 2019 (CN) 201910000680.X

(51) Int. Cl. H04W 12/06; H04W 76/14; H04W 4/80; H04W 76/30; G10L 15/22

(52) U.S. Cl. CPC H04W 12/06; H04W 76/14; G10L 2015/223; H04W 76/30; G10L 15/22; H04W 4/80

(57) ABSTRACT

Embodiments of the present disclosure provide a communication method, a communication apparatus and an electronic device. The method includes: a first device establishes a Bluetooth connection with a second device; the first device performs an authentication processing with the second device to obtain an authentication result; and the first device performs a voice-based data interaction with the second device if the authentication result is that an authentication is successful. The method can improve the connection speed, connection success rate and communication security during the communication of the device.

### CROSS-REFERENCE TO RELATED APPLICATION

This application claims priority to Chinese Patent Application No. 201910000680.X, filed on Jan. 2, 2019, which is hereby incorporated by reference in its entirety.

### TECHNICAL FIELD

Embodiments of the present disclosure relate to communication technology, and in particular to, a communication method, a communication apparatus and an electronic device.

### BACKGROUND

In the field of wireless communication, it is necessary to support both long-distance wireless communication and short-distance communication between devices. Short-distance communication can be, for example, data communication between devices in a building or a home. Data interaction between devices needs to be based on specific communication protocols. Where Bluetooth protocol is a communication protocol supported by many devices.

In the prior art, when the communication between devices is based on Bluetooth protocol, it mainly goes through the process of scanning (main device), broadcasting (slave device), establishing of communication connection and data interaction.

However, a method of short-distance communication based on the existing Bluetooth protocol has some shortcomings in connection speed, connection success rate and communication security.

### SUMMARY

Embodiments of the present disclosure provide a communication method, a communication apparatus and an electronic device, and the technical solutions are as follows.

A first aspect of the embodiments of the present disclosure provides a communication method, including:

establishing, by a first device, a communication connection with a second device;

performing, by the first device, an authentication processing with the second device to obtain an authentication result; and;

performing, by the first device, a voice-based data interaction with the second device if the authentication result is that an authentication is successful.

Further, the method further includes:

disconnecting, by the first device, the communication connection with the second device when the first device and/or the second device satisfy a first condition; where

the first condition includes at least one of the following:

power off, switching to a Bluetooth off state, receiving a disconnection instruction input from an user.

Further, the establishing, by a first device, a communication connection with the second device includes:

establishing, by the first device, a communication connection with the second device, according to manufacturer identification information broadcast by the second device and protocol version identification supported by the second device.

Further, the communication connection is established on a radio frequency communication (RFCOMM) link.

Further, the first device has an ability to connect to the Internet and the second device has an ability to receive voice or an ability to play audio.

Further, before the performing, by the first device, an authentication processing with the second device to obtain an authentication result, the method further includes:

establishing, by the first device, a communication connection with a server in a cloud; and

the performing, by the first device, an authentication processing with the second device to obtain an authentication result includes:

performing, by the first device, the authentication processing with the second device through the server to obtain the authentication result.

A second aspect of the embodiment of the present disclosure provides a communication apparatus, where the communication apparatus is applied to a first device, and the apparatus includes:

a first connection module, configured to establish a Bluetooth connection with a second device;

an authentication module, configured to perform an authentication processing with the second device to obtain an authentication result; and

an interaction module, configured to perform a voice-based data interaction with the second device when the authentication result is that an authentication is successful.

Further, the method further includes:

a disconnection module, configured to disconnect a communication connection with the second device when the first device and/or the second device satisfy a first condition; where

the first condition includes at least one of the following:

power off, switching to a communication connection, and receiving a disconnection instruction input from an user.

Further, the first connection module includes:

a connection unit, configured to establish, according to manufacturer identification information broadcast by the second device and protocol version identification supported by the second device, the communication connection with the second device.

Further, the communication connection is established on a radio frequency communication (RFCOMM) link.

Further, the first device has an ability to connect to the Internet and the second device has an ability to receive voice or an ability to play audio.

Further, the apparatus further includes:

a second connection module, configured to establish a communication connection with a server in a cloud; and

the authentication module includes:

an authentication unit, configured to perform the authentication processing with the second device through the server to obtain the authentication result.

A third aspect of the embodiment of the present disclosure provides an electronic device, including:

a memory, configured to store a program instruction; and

a processor, configured to invoke and execute the program instruction in the memory and perform the method steps of the above method embodiment.

A fourth aspect of the embodiment of the present disclosure provides a readable storage medium, where a computer program is stored in the readable storage medium for executing the method of the above method embodiment.

The communication method, the communication apparatus, and the electronic device provided by the embodiments of the present disclosure perform the authentication processing by the first device with the second device, and perform the voice-based data interaction only after the authentication is successful, thereby greatly improving the data interaction security. In addition, the first device establishes a communication connection by using a specific parameter in the information broadcast by the second device, which also greatly improves the connection speed and the connection success rate of the communication connection.

### BRIEF DESCRIPTION OF DRAWINGS

In order to illustrate the technical solutions in the present disclosure or the prior art more clearly, the accompanying drawings used in the description of the embodiments or the prior art will be briefly illustrated below. Obviously, the accompanying drawings in the following description are some embodiments of the present disclosure, and other accompanying drawings can be obtained according to the accompanying drawings without any creative work for those of ordinary skilled in the art.

FIG. 1 is a system architecture diagram of a communication method according to an embodiment of the present disclosure;

FIG. 2 is a flow chart of Embodiment 1 of a communication method provided by an embodiment of the present disclosure;

FIG. 3 is a flow chart of Embodiment 2 of a communication method provided by an embodiment of the present disclosure;

FIG. 4 is an interaction flow chart of a communication method provided by an embodiment of the present disclosure;

FIG. 5 is a module structure diagram of a communication apparatus provided by an embodiment of the present disclosure;

FIG. 6 is a module structure diagram of a communication apparatus provided by an embodiment of the present disclosure;

FIG. 7 is a module structure diagram of a communication apparatus provided by an embodiment of the present disclosure;

FIG. 8 is a module structure diagram of a communication apparatus provided by an embodiment of the present disclosure;

FIG. 9 is a module structure diagram of a communication apparatus provided by an embodiment of the present disclosure; and

FIG. 10 is an entity block diagram of an electronic device provided by an embodiment of the present disclosure.

### DESCRIPTION OF EMBODIMENTS

In order to make the purpose, technical solutions and advantages of the present disclosure clearer, the technical solutions of the embodiments of the present disclosure will be clearly and completely described below with referring to the accompanying drawings in the embodiments of the present disclosure. Apparently, the described embodiments are part of the embodiments of the present disclosure, rather than all of the embodiments. Based on the embodiments of the present disclosure, all other embodiments obtained by those of ordinary skilled in the art without creative labor are within the protection scope of the present disclosure.

In the existing communication process, the connection speed and connection success rate of a terminal device and a Bluetooth peripheral in establishing communication connections are insufficient. At the same time, after establishing communication connections between the terminal device and the Bluetooth peripheral, an authentication processing is not performed between the terminal device, the Bluetooth peripheral and the server in the data interaction process. Therefore, there is a lack of security.

The embodiment of the present disclosure, by adding an authentication processing process, improves the communication security greatly and also improves the connection speed and the connection success rate of establishing a communication connection greatly.

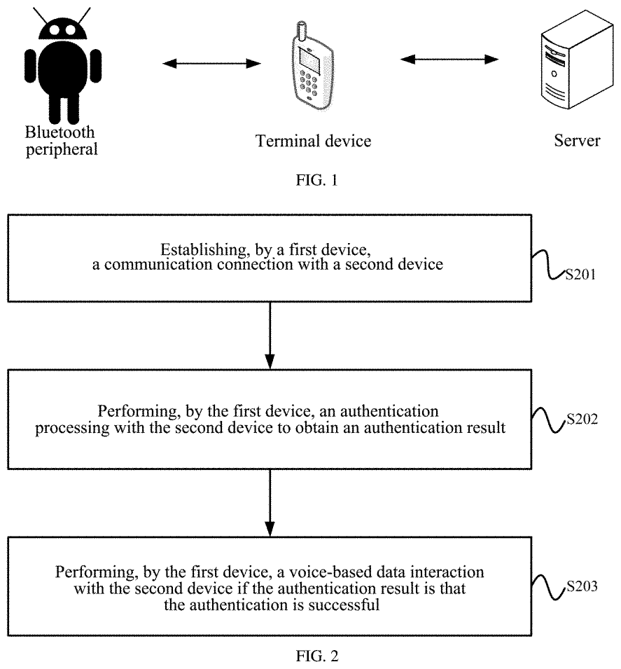

FIG. 1 is a system architecture diagram of a communication method according to an embodiment of the present disclosure, as shown in FIG. 1, the method involves a terminal device, a Bluetooth peripheral and a cloud server. Where the terminal device has an ability to connect to the Internet. For example, the terminal device can send a request for acquiring data to a device such as a server in the Internet, and receive data sent by the device in the Internet. The terminal device can be a mobile phone, a tablet computer, etc. The Bluetooth peripheral can or cannot have the ability to connect to the Internet, and has the ability to receive voice or the ability to play audio. The Bluetooth peripheral can be an intelligent speaker with built-in microphone, an intelligent vehicle bracket, etc. Both the above terminal devices and Bluetooth peripherals support Bluetooth protocol and can perform voice data interaction based on Bluetooth. The above servers can be servers in the Internet that can provide the requested data for the terminal device.

Taking the Bluetooth peripheral as an intelligent vehicle bracket for an example, in an illustrative application scenario, the user is in the vehicle where the intelligent vehicle bracket is installed, and at the same time, the user places the carried mobile phone in the vehicle. At this time, through a specific operation, the user can trigger the mobile phone to scan the surrounding Bluetooth peripheral, and perform communication connection and authentication processing with the scanned smart vehicle bracket through the method provided in the embodiment of the present disclosure. After the authentication is successful, the user can say a specific wake-up word to the intelligent vehicle bracket to wake up the intelligent vehicle bracket. After the intelligent vehicle bracket is awakened, the user can send a voice instruction to the intelligent vehicle bracket, such as, “please help me to inquire about the weather of tomorrow”, and the intelligent vehicle bracket can send the voice instruction to the terminal device which parses the voice instruction, translates it into a request for acquiring data, and sends it to the server device in the Internet. After receiving the data returned by the server, the terminal device returns the data to the intelligent vehicle bracket, and the intelligent vehicle bracket plays it to the user.

FIG. 2 is a flow chart of Embodiment 1 of a communication method provided by an embodiment of the present disclosure. The executing entity of the method is a first device which can be the terminal device shown in FIG. 1 above. As shown in FIG. 2, the method includes:

S201, establishing, by a first device, a communication connection with a second device.

Optionally, in the embodiment of the present disclosure, the first device, which can, for example, be the terminal device shown in FIG. 1 above, has the ability to connect to the Internet. And the second device, which can, for example, be the Bluetooth peripheral shown in FIG. 1 above, has the ability to receive voice or the ability to play audio, and the second device can have no ability to connect to the Internet.

Optionally, before this step, the first device can, based on the user operation, trigger to broadcast a scan message outward, where the scan message is used for Bluetooth scanning devices located in a preset range around the first device. Where the user operation can be the user opens an application (APP) on the terminal device or the user clicks on the preset control on the APP page, etc.

After the first device broadcasts the scanning message, if the second device receives the scanning message, it can broadcast a message including its own identification information outward, based on which, the first device can establish a Bluetooth connection with the second device.

S202, performing, by the first device, an authentication processing with the second device to obtain an authentication result.

S203. performing, by the first device, an voice-based data interaction with the second device when the authentication result is that the authentication is successful.

Optionally, after the communication connection is established, the first device can initiate a pairing request to the second device under the trigger of the user operation (e.g., the user clicks on the name of the second device displayed on the APP interface). Based on the signature information of the second device carried by the second device in the pairing response, the first device obtains the signature information on the server side from the server. Furthermore, before interacting with the second device, the first device firstly sends the signature information on the server side to the second device. The second device compares the signature information on the first device side with the signature information on the server side, and obtains the authentication result. If the comparison result is that the signature information matches, the authentication of the first device and the second device is successful, and the second device can send voice data to the first device. The first device then authenticates with the server side. If the result of authentication on the server side is also successful, the server provides the result data requested by the above voice data to the first device, and the first device returns the result data to the second device.

In this embodiment, the first device performs the authentication processing with the second device, and only after the authentication is successful, the voice-based data interaction can be performed, so that the security of data interaction is greatly improved. In addition, the first device establishes a communication connection through specific parameters in the broadcast information of the second device, which also greatly improves the connection speed and connection success rate of the communication connection.

In an optional embodiment, the first device can establish a communication connection with the second device based on the manufacturer identification information broadcast by the second device and the protocol version identification supported by the second device.

The details will be described below.

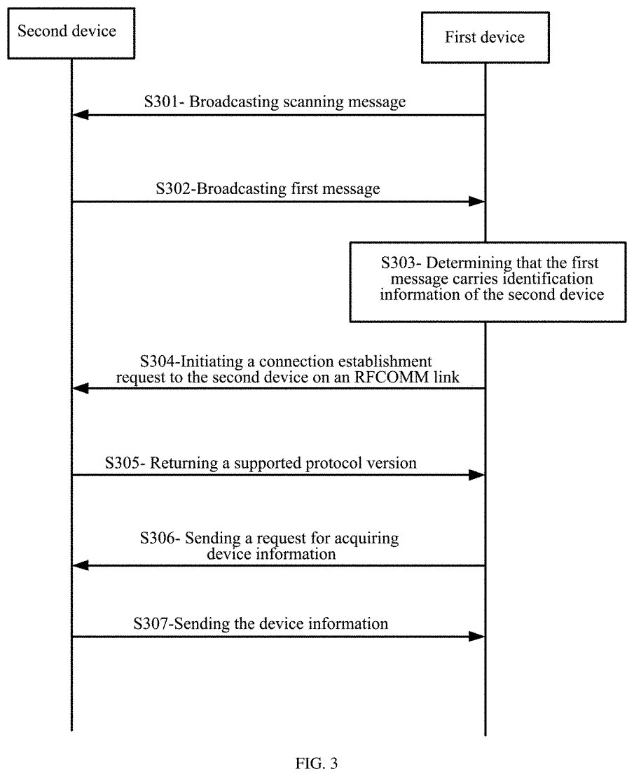

FIG. 3 is a flow chart of Embodiment 2 of a communication method provided by an embodiment of the present disclosure. As shown in FIG. 3, a process that the first device scans and establishes a communication connection with a second device includes:

S301, broadcasting, by the first device, a scanning message, where the scanning message is used for Bluetooth scanning devices located in a preset range around the first device.

As an example, when the user opens an APP of the first device or clicks on a preset control on an APP page, the first device can be triggered to broadcast the scanning message.

S302, broadcasting, by the second device a first message, where the first message is used for indicating identification information of the second device.

Optionally, the identification information of the second device can include manufacturer identification information broadcasted by the second device and protocol version identification supported by the second device.

Where the manufacturer identification of the above second device can be a manufacturer ID of a manufacturer for producing the second device, and the manufacturer ID can be a fixed ID assigned to the manufacturer in advance. The protocol version identification supported by the above second device can be a protocol version number, and the protocol can be a Bluetooth-based protocol formulated by the enterprise. The second device can support the protocol.

In addition, the identification information of the second device can also include a media access control (MAC) address of the second device.

S303, determining, by the first device, that the first message carries the identification information of the second device.

Optionally, after receiving the above first message, the first device parses the first message to determine whether the first message carries the identification information of the above second device.

S304, initiating, by the first device, a connection establishment request to the second device on an RFCOMM link.

If determining that the information broadcast by the second device carries the identification information of the second device, the first device establishes a communication connection with the second device directly on the RFCOMM link.

S305, returning, by the second device, a supported protocol version to the first device.

S306, confirming, by the first device, support for the protocol version and sending a request for acquiring device information to the second device.

S307, sending, by the second device, the device information to the first device.

In the existing processing method, the first device firstly needs to establish a communication connection with the second device on the Bluetooth Low Power (BLE) link. After it is confirmed that the second device supports RFCOMM link transmission, the BLE connection is disconnected, and then the RFCOMM connection is re-established. In the embodiment of the present disclosure, according to the manufacturer identification information broadcast by the second device and the protocol version identification supported by the second device, the first device can directly establish the connection on the RFCOMM link, thereby greatly improving connection speed and connection success rate.

In another embodiment, when the above first device and/or the above second device meet a first condition, the first device can disconnect the communication connection with the second device.

Where the above first condition includes at least one of the following:

power off, switching to a Bluetooth off state, receiving a disconnection instruction input from an user.

As an example, when the user closes the Bluetooth switch of the first device on the system configuration interface of the first device, the first device switches to the Bluetooth Off state, and when the first device switches to this state, the first device can send a disconnection request to the second device to disconnect the communication connection with the second device.

As an example, when the user clicks a disconnection button corresponding to the second device displayed on the APP interface of the first device, the first device determines receiving the disconnection instruction for the second device input by the user, and the first device can then send the disconnection request to the second device to disconnect the communication connection with the second device.

In another embodiment, before the first device performs an authentication processing with the second device and obtains an authentication result, the first device can also establish a communication connection with the server in the cloud.

Specifically, as mentioned above, after the communication connection is established, the first device can initiate a pairing request to the second device under the triggering of the user operation (e.g., the user clicks on the name of the second device displayed on the APP interface). Where the second device carries the signature information of the second device in the pairing response. After that, the second device needs to obtain the signature information on the server side from the server. Therefore, before that, the first device can firstly establish a communication connection with the server.

When the first device establishes a communication connection with the server, the first device can perform the authentication processing with the second device through the server to obtain an authentication result.

Specifically, after receiving the signature information of the second device, the first device can send a signature verification request to the server, and carry the signature information of the second device in the request. Accordingly, the server generates the signature information of the server and sends it to the first device. The first device sends the signature information on the server side to the second device. The second device compares the signature information on the first device side with the signature information on the server side, and obtains the authentication result. If the comparison result is that the signature information matches, the authentication of the first device and the second device is successful and the second device can send voice data to the first device. Further, the first device can perform the authenticate processing with the server side. If the authentication result on the server side is also successful, the server provides the result data requested by the above voice data to the first device, and the first device returns the result data to the second device.

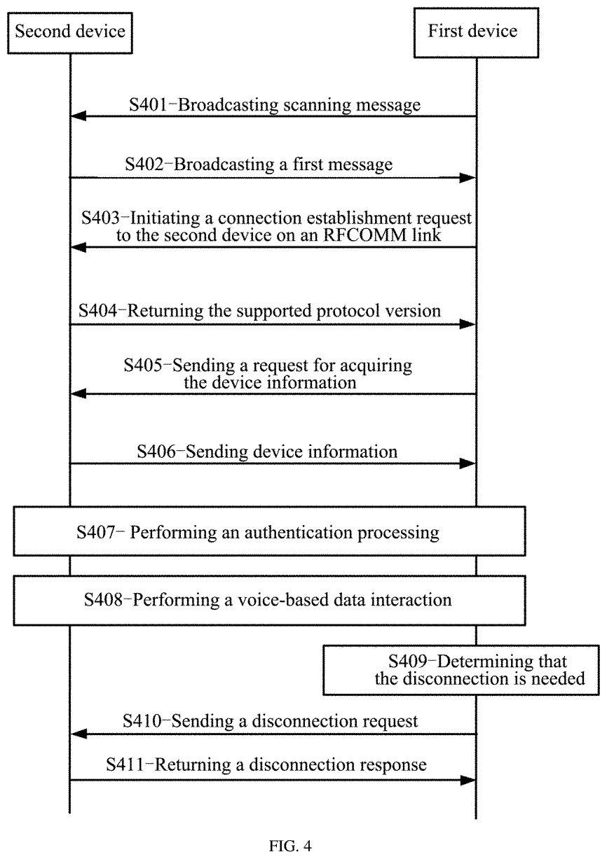

FIG. 4 is an interaction flow chart of a communication method provided by an embodiment of the present disclosure. As shown in FIG. 4, the communication process among the first device, the second device and the server includes:

S401, broadcasting, by the first device, a scanning message, where the scanning message is used for Bluetooth scanning devices located in a preset range around the first device.

S402, broadcasting, by the second device, a first message, where the first message is used to indicate identification information of the second device.

S403, initiating, by the first device, a connection establishment request to the second device on an RFCOMM link according to the first message.

S404, returning, by the second device, a supported protocol version to the first device.

S405, confirming, by the first device, support for the protocol version and sending a request for acquiring device information to the second device.

S406, sending, by the second device, the device information to the first device.

S406, sending, by the second device, the device information to the first device.

S407, performing, by the first device, an authentication processing with the second device.

S408, performing, by the first device, a voice-based data interaction with the second device interact.

S409, determining, by the first device, that the communication connection with the second device needs to be disconnected.

S410, sending, by the first device, a disconnection request to the second device.

S411, returning, by the second device, a disconnection response to the first device.

For the specific implementation process of the above steps, reference can be made to the foregoing embodiments, and will not be described herein again.

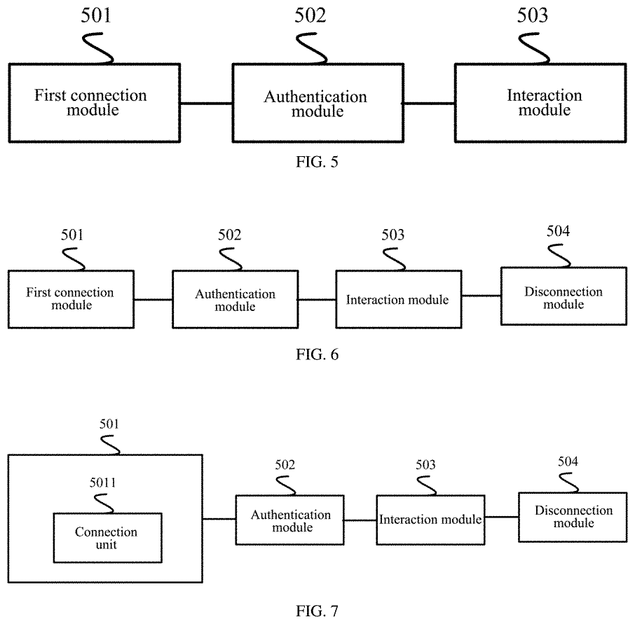

FIG. 5 is a module structure diagram of a communication apparatus provided by an embodiment of the present disclosure, which is applied to a first device. As shown in FIG. 5, the apparatus includes:

a first connection module 501, configured to establish a Bluetooth connection with the second device.

an authentication module 502, configured to perform an authentication with the second device to obtain an authentication result.

an interaction module 503, configured to perform a voice-based data interaction with the second device when the authentication result is that the authentication is successful.

The apparatus is used to implement the foregoing method embodiments, has the similar implementation principle and technical effect, and will not be described herein again.

FIG. 6 is a module structure diagram of a communication apparatus provided by an embodiment of the present disclosure. As shown in FIG. 6, the apparatus also includes:

a disconnection module 504, configured to disconnect the communication connection with the second device when the first device and/or the second device satisfy a first condition.

The first condition includes at least one of the following:

power off, switching to a Bluetooth off state, and receiving a disconnection instruction input from an user.

FIG. 7 is a module structure diagram of a communication apparatus provided by an embodiment of the present disclosure. As shown in FIG. 7, the first connection module 501 includes:

a connection unit 5011, configured to establish the communication connection with the second device according to manufacturer identification information broadcast by the second device and protocol version identification supported by the second device.

In another embodiment, the communication connection is established on an RFCOMM link.

In another embodiment, the first device has the ability to connect to the Internet, and the second device has the ability to receive voice or the ability to play audio.

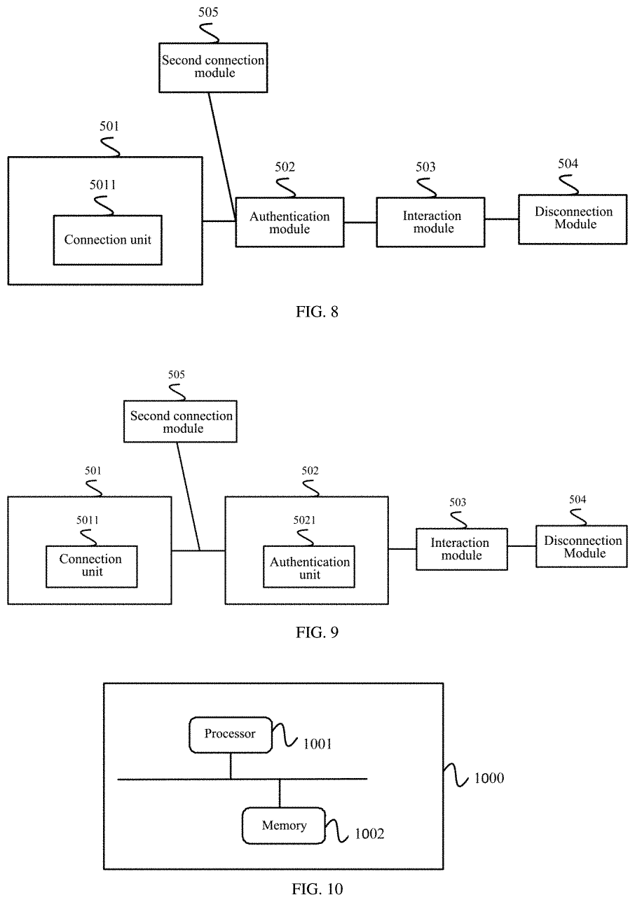

FIG. 8 is a module structure diagram of a communication apparatus provided by an embodiment of the present disclosure. As shown in FIG. 8, the apparatus further includes:

a second connection module 505, configured to establish a communication connection with the server in the cloud.

FIG. 9 is a module structure diagram of a communication apparatus provided by an embodiment of the present disclosure. As shown in FIG. 9, the authentication module 502 includes:

an authentication unit 5021, configured to perform an authentication processing on the second device through the server to obtain the authentication result.

FIG. 10 is an entity block diagram of an electronic device provided by an embodiment of the present disclosure. As shown in FIG. 10, the electronic device 1000 includes:

a memory 1002, configured to store program instructions.

a processor 1001, configured to invoke and execute the program instructions in memory 1002 to execute the method steps executed by the first device in the above method embodiments.

Those skilled in the art will appreciate that all or part of the steps to implement the various method embodiments described above may be accomplished by hardware associated with the program instructions. The foregoing program can be stored in a computer readable storage medium. The program, when executed, performs the steps including the above method embodiments; and the foregoing storage medium includes various media which can store an program code, such as a ROM, a RAM, a magnetic disk, or an optical disk.

Finally, it should be noted that the above embodiments are merely intended for illustrating the technical solutions of the present application, but not for limiting thereto; although the present application is illustrated in detail with reference to the foregoing embodiments, those skilled in the art should understand that they may still make modifications to the technical solutions described in the foregoing embodiments or make equivalent substitutions to part or all technical features thereof, however, these modifications or substitutions do not make the essence of the corresponding technical solutions depart from the scope of the solutions of the embodiments of the present application.

What is claimed is:

1. A communication method, comprising:
establishing, by a first device, a communication connection with a second device;
performing, by the first device, an authentication processing with the second device to obtain an authentication result; and
performing, by the first device, a voice-based data interaction with the second device if the authentication result is that an authentication is successful.

2. The method according to claim 1, further comprising:
disconnecting, by the first device, the communication connection with the second device when at least one of the first device and the second device satisfies a first condition; wherein
the first condition comprises at least one of the following:
power off, switching to a Bluetooth off state, receiving a disconnection instruction input from an user.

3. The method according to claim 1, wherein the establishing, by a first device, a communication connection with a second device comprises:
establishing, by the first device, the communication connection with the second device, according to manufacturer identification information broadcast by the second device and protocol version identification supported by the second device.

4. The method according to claim 3, wherein the communication connection is established on a radio frequency communication (RFCOMM) link.

5. The method according to claim 1, wherein the first device has an ability to connect to the Internet, and the second device has an ability to receive voice or an ability to play audio.

6. The method according to claim 1, wherein before the performing, by the first device, an authentication processing with the second device to obtain an authentication result, the method further comprises:
establishing, by the first device, the communication connection with a server in a cloud; and
the performing, by the first device, an authentication processing with the second device to obtain an authentication result comprises:
performing, by the first device, the authentication processing with the second device through the server to obtain the authentication result.

7. The method according to claim 1, wherein the communication connection is a Bluetooth connection.

8. A communication apparatus, wherein the communication apparatus is applied to a first device, and the apparatus comprises: a memory, configured to store a program instruction; and
a processor, configured to invoke and execute the program instruction in the memory, which, when executed by the processor, causes the processor to:
establish a communication connection with a second device;
perform an authentication processing with the second device to obtain an authentication result; and
perform a voice-based data interaction with the second device when the authentication result is that an authentication is successful.

9. The apparatus according to claim 8, wherein the program instruction further causes the processor to:
disconnect the communication connection with the second device when at least one of the first device and the second device satisfies a first condition; wherein
the first condition comprises at least one of the following:
power off, switching to a Bluetooth off state, and receiving a disconnection instruction input from an user.

10. The apparatus according to claim 8, wherein the program instruction further causes the processor to: establish, according to manufacturer identification information broadcast by the second device and protocol version identification supported by the second device, a communication connection with the second device.

11. The apparatus according to claim 10, wherein the communication connection is established on a radio frequency communication (RFCOMM) link.

12. The apparatus according to claim 8, wherein the first device has an ability to connect to the Internet and the second device has an ability to receive voice or an ability to play audio.

13. The apparatus according to claim 8, wherein the program instruction further causes the processor to:
establish a communication connection with a server in a cloud; and
perform the authentication processing with the second device through the server to obtain the authentication result.

14. The apparatus according to claim 8, wherein the communication connection is a Bluetooth connection.

15. A readable storage medium, wherein a computer program is stored in the readable storage medium for executing operations, comprising:
establishing, by a first device, a communication connection with a second device;
performing, by the first device, an authentication processing with the second device to obtain an authentication result; and
performing, by the first device, a voice-based data interaction with the second device if the authentication result is that an authentication is successful.

16. The readable storage medium according to claim 15, wherein the operations further comprise:
disconnecting, by the first device, the communication connection with the second device when at least one of the first device and the second device satisfies a first condition; wherein
the first condition comprises at least one of the following:
power off, switching to a Bluetooth off state, receiving a disconnection instruction input from an user.

17. The readable storage medium according to claim 15, wherein the establishing, by a first device, a communication connection with a second device comprises:
establishing, by the first device, the communication connection with the second device, according to manufacturer identification information broadcast by the second device and protocol version identification supported by the second device.

18. The readable storage medium according to claim 17, wherein the communication connection is established on a radio frequency communication (RFCOMM) link.

19. The readable storage medium according to claim 15, wherein the first device has an ability to connect to the Internet, and the second device has an ability to receive voice or an ability to play audio.

20. The readable storage medium according to claim 15, before the performing, by the first device, an authentication processing with the second device to obtain an authentication result, the operations further comprise:
establishing, by the first device, the communication connection with a server in a cloud; and
the performing, by the first device, an authentication processing with the second device to obtain an authentication result comprises:
performing, by the first device, the authentication processing with the second device through the server to obtain the authentication result.
